(19) United States
(12) Patent Application Publication
(10) Pub. No.: US 2026/0023863 A1
(43) Pub. Date: Jan. 22, 2026

(54) MODIFYING THE PERMISSIONS OF A SECURITY CONTEXT BASED ON THE DEVICE STATE

(71) Applicant: CRYPTOGRAPHY RESEARCH, INC., San Jose, CA (US)

(72) Inventors: Matthew E. Orzen, San Francisco, CA (US); Joel Wittenauer, Pleasanton, CA (US)

(21) Appl. No.: 18/640,829

(22) Filed: Apr. 19, 2024

Related U.S. Application Data
(60) Provisional application No. 63/462,736, filed on Apr. 28, 2023.

(51) Int. Cl. G06F 21/60; G06F 21/72

(52) U.S. Cl. CPC G06F 21/604; G06F 21/602; G06F 21/72; G06F 2221/2113

(57) ABSTRACT

A computing device receives a request to run an application. The application is associated with a security context. The computing device obtains one or more permissions associated with the security context and modifies the one or more permissions based on a state of the computing device. The application is run based on the modified one or more permissions.

### RELATED APPLICATION

This application claims the benefit of U.S. Provisional Application No. 63/462,736, filed Apr. 28, 2023, the entire content of which is hereby incorporated by reference.

### TECHNICAL FIELD

Aspects and implementations of the disclosure relate to roots of trust, and more specifically, to systems and methods for modifying the permissions of a security context based on the device state.

### BACKGROUND

Some computing systems can apply a set of access control settings (referred to as “permissions”) for an application either before it executes or during the runtime of the application (e.g., a container, a pod, a virtual machine, a native application, an executable image, etc.). A security context defines these permissions for the application. These permissions can be used for the application, the user that requested the execution of the application, or any combination thereof. These permissions can be managed by software executing at a higher privilege level, such as kernel access controls.

A secure root of trust is like a general-purpose computing system in that there are access controls in place. A root of trust often differs from a general-purpose computing system's access control, where the root of trust access control is managed by hardware state machines implemented in the peripherals (e.g., an auxiliary hardware device). For example, when an executable code of an application is loaded, the root of trust verifies the executable code under some previously established security context known to the root of trust. This security context includes a set of permissions that are used for the application at the root of trust peripherals. For example, for an executable image, the peripherals can enforce the security context's permissions such that the image's executing code can access only allowed secure data assets (e.g., encrypted data, cryptographic keys, authenticated data, a signed certificate, etc.). In certain systems, a root of trust has the security context and permissions provisioned to its non-volatile memory (NVM) or one-time-programmable (OTP) memory prior to loading an image to execute under that security context. Provisioning can include the process of creating and/or setting up an information technology infrastructure, and includes the operations required to manage user and system access to various resources.

### BRIEF DESCRIPTION OF THE DRAWINGS

The present disclosure is illustrated by way of example, and not by way of limitation, in the figures of the accompanying drawings.

FIG. 1 illustrates a network diagram of a computer system, in accordance with some implementations of the disclosure.

FIG. 2 is a sequence diagram illustrating creation and distribution of device state access control policy, in accordance with some implementations of the disclosure.

FIG. 3 schematically illustrates example metadata reflecting the device state access control policy, in accordance with some implementations of the present disclosure.

FIG. 4 is a sequence diagram illustrating the use of a device state access control policy during execution of an application, in accordance with some implementations of the disclosure.

FIG. 5 depicts a flow diagram of an example method of applying a device state access control policy during execution of an application, in accordance with some implementations of the disclosure.

FIG. 6 depicts a flow diagram of an example method of generating device state access control policy, in accordance with some implementations of the disclosure.

FIG. 7 is a block diagram illustrating an exemplary computer system, in accordance with some implementations of the disclosure.

### DETAILED DESCRIPTION

Technologies for modifying the permissions of a security context for an application based on the state of a device requested to run the application are described. The following description sets forth numerous specific details, such as examples of specific systems, components, methods, and so forth, in order to provide a good understanding of several implementations of the present disclosure. It will be apparent to one skilled in the art, however, that at least some implementations of the present disclosure can be practiced without these specific details. In other instances, well-known components or methods are not described in detail or presented in simple block diagram format to avoid obscuring the present disclosure unnecessarily. Thus, the specific details set forth are merely exemplary. Implementations can vary from these exemplary details and still be contemplated to be within the scope of the present disclosure.

In general, a computing device can include a hardware root of trust (RoT) that utilizes a security context to perform its responsibilities and provide security guarantees. Data in the security context can include a device stage (e.g., lifecycle, characterization values, or the like), runtime or execution context, secure data assets (e.g., encrypted data, cryptographic keys, authenticated data, a signed certificate, etc.), and so forth. For operation of the hardware RoT, one or more security contexts can be provisioned to the computing device and stored in secure memory, such as one-time-programmable (OTP) memory. Each security context can be assigned a set of permissions (e.g., access to secure data assets). When an executable code of an application (e.g., a container, a pod, a virtual machine, a native application, an executable image, etc.) is loaded on the computing device, the application can be executed under an assigned security context. In particular, when the executable code of the application is loaded and/or is being executed, the RoT can search its OTP (or other memory) to determine the permissions (e.g., access rights) assigned to the application. For example, the RoT can grant the application access to certain data assets allowed by the security context. In some systems, the security contexts cannot be modified for the life cycle of the computing device.

Each computing device can operate in different device states. A device state can be defined by any measurable value of the device (e.g., life cycle state, a time of date, a certain host operating the computing device, a temperature of the device, a detected peripheral coupled to the computing device, etc.). In one example, the device state can refer to a life cycle state. For example, a target device can have a blank device state (e.g., a new device), a tested state (e.g., tested by one or more tester devices), a provisioned state (e.g., provisioned with one or more security contexts), a normal operating state (e.g., the intended use of the device where the failure rate is relatively constant), an end-of-life state (e.g., the state where the failure rate increases), etc. In another example, different host devices can use the computing device (e.g., the device can be considered in a different state for each host). However, these different device states are typically not taken into consideration when deciding what permissions should be assigned to an application requested to run on the device. As a result, the application's access to data assets may be unnecessarily restrictive for a particular device state, causing the application not to perform some of its intended operations, or overly permissive for a particular device state, causing security of some data assets to be jeopardized.

Aspects of the disclosure address at least the above challenges among others by modifying the permissions of a security context based on a device state. In particular, a target device can be provisioned with one or more security contexts. Each security context can define a set of permissions for an application, such as, for example, a container, a pod, a virtual machine, a native application, an executable image, etc. The permissions can provide runtime or execution context, access to one or more secure data assets (e.g., encrypted data, cryptographic keys, authenticated data, a signed certificate, etc.), and so forth. A provisioning device can create and distribute, to the target computing device, a device state access control policy for one or more of the provisioned security contexts. The device state access control policy (e.g., stored in a metadata data structure such as a metadata table) can reference modifications to the permissions of each of the security contexts based on the current state of the target device. In particular, the device state access control policy can indicate which permissions to modify when the computing device is in or transitioning to one or more particular states.

When a host system requests the execution of an application on the computing device, the computing device can obtain the security context(s) corresponding to the application, and modify the permissions based on the device state access control policy. For example, the computing device can grant, to the application, access to cryptographic keys allowed by the device state access control policy.

As noted, a technical problem addressed by implementations of the disclosure is the lack of ability to adjust security contexts provisioned to a computing device in accordance with different device states.

A technical solution to the above identified technical problems can include provisioning the computing device with device state access control policy(ies) that define different permissions for different device states. Thus, the technical effect can include the computing device being configured to modify existing security contexts based on a state of the device, thereby providing the application with sufficient access to data assets without jeopardizing security of these data assets.

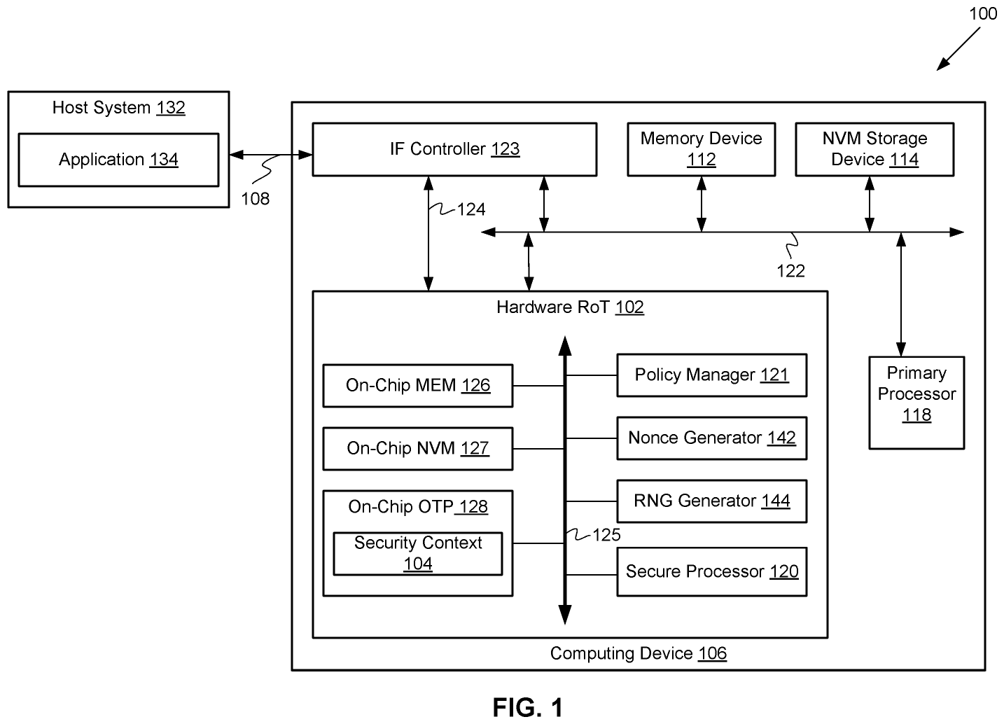

FIG. 1 is a block diagram of a computing system 100, according to some implementations. As illustrated, computing system 100 includes computing device 106 and host system 132. Computing device 106 includes a hardware RoT 102, interface (IF) controller 123, memory device 112, non-volatile memory (NVM) storage device 114, and primary processor 118 (e.g., a central processing unit (CPU), or the like). Computing device 106 includes interface circuitry, such as an interface controller 123, to receive messages from a requestor (e.g., host system 132) over a communications link 108. Computing device 110 further includes a primary processor 118 coupled to the interface controller 123 to process requests in the received messages, and a secondary processor, e.g., a secure processor 120 of RoT 102, is coupled to the interface controller 123 to perform cryptographic functions on behalf of the primary processor 118. Interface controller 123, hardware RoT 102, primary processor 118, memory device 112, and non-volatile storage device 114 can be coupled together via a bus 122.

In some implementations, the primary processor 118 is responsible for overall control of the computing device 106, while the secure processor 120 operates on behalf of the primary processor 118. In one implementation, the secure processor 120 carries out cryptographic operations on behalf of the primary processor 118. Acting on behalf of the primary processor 118, the secure processor 120 can decrypt incoming requests, encrypt outgoing responses from the primary processor 118, perform attestation operations and other cryptographically-related tasks as the need arises. In some implementations, the secure processor 120 is responsible for a secure boot process for the computing device 106.

In some implementations, the primary processor 118 and the secure processor 120 take the form of processor cores disposed on a single integrated circuit (IC) die, or chip, forming a system-on-chip (SoC). In such implementations, the bus 122 can form one or more of an advanced extensible interface (AXI) for high-speed communications on-chip between the primary processor 118 and the secure processor 120, and/or an advanced peripheral bus (APB) for low-speed control signals transferred on-chip between the processors. Other implementations can employ separate processor chips disposed on a common substrate to form a chiplet, multi-chip module (MCM) or system-in-package (SIP). Yet other implementations can employ an interconnected system of multiple packaged processors disposed on separate substrates.

In some implementations, the primary processor 118 controls the transfer of requests, data, and/or messages dispatched between the computing device 106 and the requestor (e.g., host system 132) via the communications link 108. The requests can take the form of commands and/or interrupts alerting the primary processor 118 to actions that are to be taken. For one implementation, the communications link 108 at least partially takes the form of a serial management bus (SMBus), inter-integrated circuit (I2C), improved inter-integrated circuit (I3C), or similar chip communications link. In certain implementations, as explained below, the communications link 108 can also include a high-bandwidth Compute Express Link (CXL™) interface.

Processor 118 can interface, over bus 122, with memory device 112 and non-volatile storage device 114. Memory device 112 can refer to computer memory that requires power to maintain the stored information. Memory device 112 can include random-access memory (RAM), dynamic random-access memory (DRAM), synchronous DRAM (SDRAM), static memory (e.g., static random-access memory (SRAM)) etc. Non-volatile storage device 114 can be any type of computer memory that can retain stored information even after power is removed, such as flash memory (e.g., NAND flash, solid-state drives (SSD), etc.), read-only memory (ROM), EPROM (erasable programmable ROM), EEPROM (electrically erasable programmable ROM), hard disk drives, optical drives, etc.

Hardware RoT 102 includes on-chip memory 126, on-chip non-volatile memory 127, one-time-programming (OTP) memory 128, secure processor 120, policy manager 121, nonce generator 142, and random number generator 144. The component of hardware RoT 102 can be connected via bus 125 which can have its own logic circuits, e.g., a bus interface logic unit. On-chip memory 126 can include volatile memory, and be similar to memory device 112. On-chip non-volatile memory 127 can include non-volatile memory and be similar to non-volatile storage device 114.

On-chip OTP memory 128 can be a type of digital memory implemented in circuitry or silicon of a device that can be programmed and cannot be changed after being programmed. For example, security context data and/or data assets can be programmed onto OTP memory 128 and the data cannot be changed in the OTP memory 128 after the programming. OTP memory 128 can be a type of digital memory where the setting of each bit of the OTP memory 128 is locked by a fuse (e.g., an electrical fuse associated with a low resistance and designed to be permanently break an electrically conductive path after the programming or setting of a corresponding bit) or an antifuse (e.g., an electrical component associated with an initial high resistance and designed to permanently create an electrically conductive path after the programming or setting of a corresponding bit). As an example, each bit of the OTP memory 128 can start with an initial value of ‘0’ and can be programmed or set to a later value of ‘1’ (or vice versa). Thus, in order to program or set a device specific key or a unique device identification (ID) with a value of ‘10001’ into OTP memory 128, two bits of OTP memory 128 can be programmed from the initial value of ‘0’ to the later value of ‘1.’ Once the two bits of OTP memory 118 have been programmed to the later value of ‘1’, then the two bits cannot be programmed back to the value of ‘0.’ As such, the bits of OTP memory 118 can be programmed once and cannot be changed once programmed.

In some implementations, on-chip OTP memory 128 can store one or more security contexts 104. In other implementations, other memory devices can store the security context(s) 104, such as, for example, on-chip non-volatile storage device 127. A security context can define a set of permissions for the application (e.g., application executable code 134) run by host system 132. These permissions can be used for the application, the user that requested the execution of the application, or any combination thereof. In an illustrative example, host system 132 can deliver application executable code 134 to hardware RoT 102 and secure processor 120 can execute the application executable code 132 inside the boundary of hardware RoT 102 (e.g., hardware RoT 102 can apply the policies of the permissions based on device state). In some implementations, the permissions can grant access to a secure data asset, runtime or execution context. A secure data asset can refer to sensitive data that is generated and/or stored, at least in part, by RoT 102. A data asset can include one or more of encrypted data (e.g., cryptographic keys), authenticated data (e.g., confirmation of the origin and/or integrity of the data), or a certificate (e.g., a data block authenticated using an authenticating digital signature). In some implementations, the data asset can include a sequence (e.g., a set of commands) or script. In some implementations, the data asset can include specialized software code.

Nonce generator 142 can generate a nonce (e.g., a nonce value). The nonce value can be an arbitrary value used just once in a cryptographic communication or operation. In some implementations, the nonce value can be a concatenation of one or more of parameters, such as an initialization vector (IV), the memory address referencing a location of the user data, a counter value, a random number, etc. In some implementations, the nonce can be a random number obtained from a random number generator 144.

Random number generator 144 can be a hardware random number generator (HRNG) or true random number generator (TRNG) that generates random numbers from a physical process (rather than by means of an algorithm). In some implementations, random number generator 144 can generate random numbers based on microscopic phenomena that generate low-level, statistically random “noise” signals, such as thermal noise, the photoelectric effect, involving a beam splitter, and other quantum phenomena. In other implementations, random number generator 144 can refer to a software implemented application configured to generate random numbers. In some implementations, nonce generator and/or random number generator 144 can be operated by primary processor 118 and located outside of hardware RoT 102.

Host system 132 can be or include a memory controller for controlling data programmed to and data read from a memory device memory device 112 and non-volatile memory device 114. Host system 132 can be any computer or other device that communicates with target computing device 106. In some implementations, host system 132 can run executable code 134 of an application. The application can refer to software that runs on a high-level operating system (OS), such a Linux or other OS. The application can perform one or more custom functions and/or procedures, and/or make calls over communications link 106 to retrieve data and/or request services.

Policy manager 121 can provide access, to an application, to data allowed by the permissions of a corresponding security context as modified by a device state access control policy. A device state access control policy can be used to modify the set of permissions based on a device state of the computing device, as explained in greater detail herein. A device state can be defined by any measurable value of computing device 106, such as, for example, a life cycle state of computing device 106, a time of date, an identifier of the host system 132, an identifier of a user operating host system 132, a temperature computing device 106, a detected peripheral coupled to computing device 106, etc.

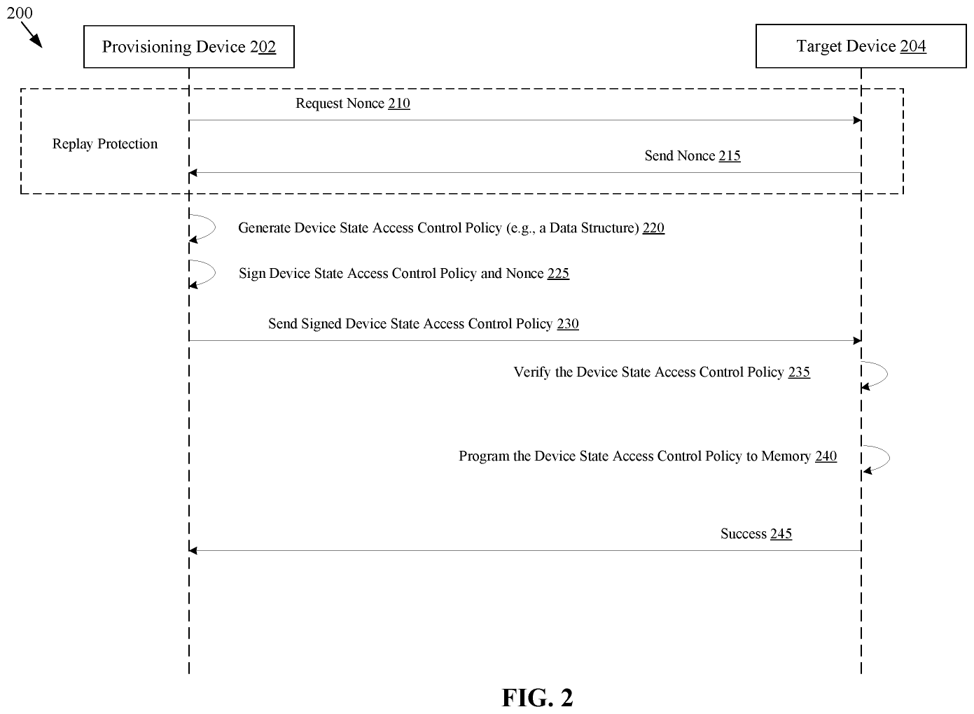

FIG. 2 is a sequence diagram illustrating creation and distribution of device state-based access control policies, in accordance with some implementations of the disclosure. Diagram 200 can include similar elements as illustrated in computing system 100 as described with respect to FIG. 1. It can be noted that elements of FIG. 1 can be used herein to help describe FIG. 2. The operations described with respect to FIG. 2 are shown to be performed serially for the sake of illustration, rather than limitation. Although shown in a particular sequence or order, unless otherwise specified, the order of the operations can be modified. Thus, the illustrated implementations should be understood only as examples, and the illustrated operations can be performed in a different order, while some operations can be performed in parallel. Additionally, one or more operations can be omitted in some implementations. Thus, not all illustrated operations are required in every implementation, and other process flows are possible. In some implementations, the same, different, fewer, or greater operations can be performed.

Diagram 200 illustrates provisioning device 202 and target device 204. Target device 204 can be similar or the same as computing device 106 of FIG. 1. For example, target device 204 can include a hardware RoT. In some implementations, provisioning device 202 is a computing device configured to provision data to target device 204.

At operation 210, provisioning device 202 requests a nonce from target device 204. At operation 215, provisioning device 202 receives a nonce from target device 204. In some implementations, target device 204 can generate a nonce by sampling a random number generator to obtain a random value and generate a nonce based on the random value (e.g., apply a formula to the random value). In some implementations, the nonce can be the random value itself. Target device 204 can store a copy of the nonce on its memory (e.g., volatile memory 112, 126, non-volatile memory, 114, 127, etc.).

The nonce can be used for protection against a replay attack. A replay attack is a form of hardware attack in which previously valid and authenticated data in the memory is maliciously or fraudulently copied and/or moved to a different location in the memory, at different instants of time. In an example, previously authenticated data can be reused at a different time to mislead a computer system into a specific state or to execute a specific task. The malicious party can mislead the system to re-run a task or change system status to obtain some benefit (e.g., access to sensitive information). The nonce can be used in an authentication protocol as a means of preventing replay attacks by preventing prior communications from being reused. In particular, the nonce can be used to prove that the communication received by target device 204 was sent by the intended sender (e.g., provisioning device 202) and was not intercepted and resent by a malicious party.

At operation 220, provisioning device 202 generates a device state access control policy. In some implementations, the device state access control policy can be stored in a data structure (e.g., a metadata table). The device state access control policy data structure can indicate how to modify, for each security context, the base access control policy based on the particular state of the target device. In particular, the device state access control policy can indicate which permissions of a security context to modify during one or more device states. In some implementations, the access states can indicate a type of permission to be applied to the context and/or use case (e.g., add, subtract, replace, etc.).

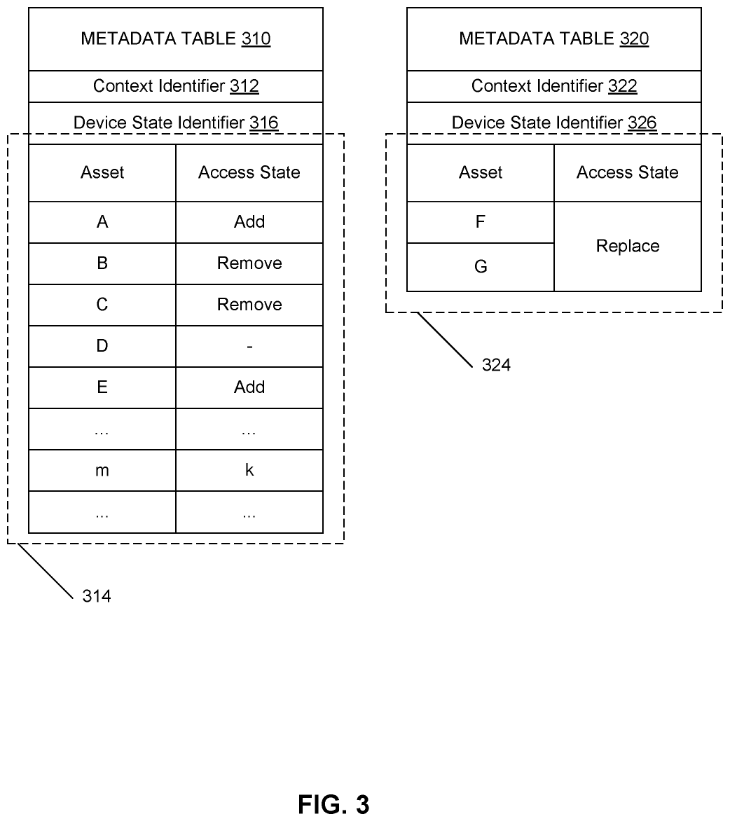

FIG. 3 schematically illustrates example metadata reflecting the device state access control policy, in accordance with some implementations of the present disclosure. In particular, metadata table 310 can include context identifier 312, access control policy 314, and device state identifier 316. Metadata table 320 can include a context identifier 322, access control policy 324, and device state identifier 326. Context identifier 312, 322 can be used to identify the security context to which the device state access control policy applies. In some implementations, an identifier can be a number, a string, a cryptographic key, etc. Device state identifier 316, 326 can be used to identify to which device state the access control policy applies. A device state can be defined by any measurable value of a device (e.g., computing device 106). For example, a device state can refer to a life cycle state (e.g., a blank device state, a tested state, a provisioned state, a normal operating state, an end-of-life state, etc.), a time of date, a certain host operating the computing device, a temperature of the device, a detected peripheral coupled to the computing device, etc. In some implementations, the device state can include a mapping between a state type and a value. For example, the device state can be identified by mapping Lifecycle=Blank, Date>01/01/2024, etc. In implementations where there are multiple device states being compared, combination logic can be used. For example, the device state can be identified by combination logic Lifecycle=Blank AND Date>01/01/2024, Lifecycle=Blank OR Date>01/01/2024, etc. As such, in certain implementations, the device state can be determined using a logical statement(s) rather than a metadata table.

Access control polices 314, 324 can be indicative of secure data asset and the corresponding access state under the device state access control policy. For example, as illustrated by metadata table 310, when target device 204 is in a device state identified by device state identifier 316, all applications operating under the security context identified by context identifier 312 will include the following modifications: secure data assets A and E are added (the application operating under the security context identified by context identifier 312 can access secure data assets A and E), secure data assets B and C are removed (the application operating under the security context identified by context identifier 312 can no longer access secure data assets B and C), and access to assess D remains unchanged (e.g., the permission listed in the base access control policy remains in effect). In some implementations, certain permissions can be omitted from access control policies 314. In one example, when a permission is omitted from access control polices 314, hardware RoT 102 (or other processing logic) can assume that the omitted permission remains the same.

In another example, as illustrated by metadata table 320, when target device 204 is in a device state identified by device state identifier 326, all applications operating under the security context identified by context identifier 312 will include the following modifications: access to all of the secure data assets listed in the base access control policy are replace with access to secure data assets F and G.

Returning to FIG. 2, at operation 225, provisioning device 202 signs the device state access control policy and the nonce using a cryptographic signature. For example, provisioning device 202 can sign the device state access control policy and nonce using a private key of a public-private key pair associated with an application running on target device 204, where the public key of the key pair is managed by target device 204, or vice versa. In implementations where replay protection is not used, at operation 225, provisioning device 202 signs only the device state access control policy. In other implementations, provisioning device 202 can sign or encrypt the device state access control policy and/or nonce using other methods or operations.

At operation 230, provisioning device 202 sends the signed device state access control policy and the signed nonce to target device 204.

At operation 235, target device 204 verifies the signature. In some implementations, target device 204 can verify the signature using, for example, a cryptographic key (e.g., a public key of the private-public key pair associated with an application running on target device 204). In other implementations, target device 204 can perform other verification and/or decryption operations.

In implementations using replay protection, target device 204 can append the nonce to the signed data prior to performing a verification procedure on the appended signed data. Since target device 204 generated the nonce, it can obtain the nonce from its memory. Responsive to performing a successful verification procedure, target device 204 can determine that the device state access control policy is authentic.

At operation 240, target device 204 stores the device state access control policy to memory. For example, the device state access control policy can be stored to the target device's OTP memory, non-volatile memory, etc. Operation 240 can be performed in response to verifying the nonce, successfully decrypting the encrypted device state access control policy, verifying the cryptographic signature, etc.

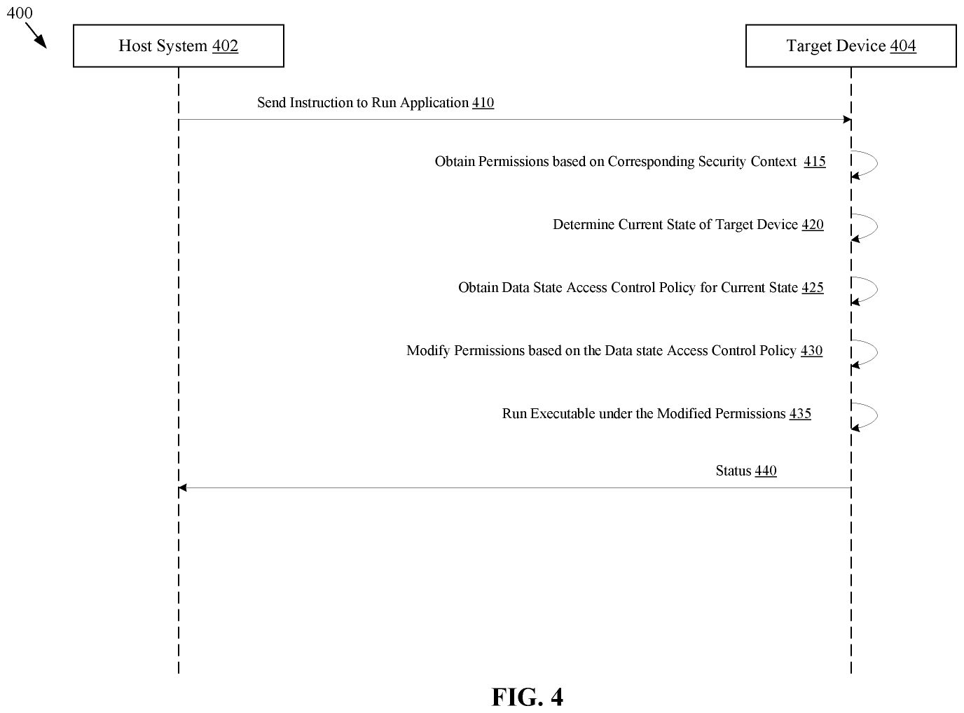

In some implementations, target device 204 can send an indication to provisioning device 202 (e.g., at operation 245) that the verification was successful and/or that the device state access control policy was successfully stored to target device 204. Target device 204 can now implement the permissions of the device state access control policy for each corresponding device state, as will be discussed in in more detail below with reference to FIG. 4.

FIG. 4 is a sequence diagram illustrating application of a device state access control policy during execution of an application, in accordance with some implementations of the disclosure. Diagram 400 can include similar elements as illustrated in computing system 100 as described with respect to FIG. 1. It can be noted that elements of FIG. 1 can be used herein to help describe FIG. 4. The operations described with respect to FIG. 4 are shown to be performed serially for the sake of illustration, rather than limitation. Although shown in a particular sequence or order, unless otherwise specified, the order of the operations can be modified. Thus, the illustrated implementations should be understood only as examples, and the illustrated operations can be performed in a different order, while some operations can be performed in parallel. Additionally, one or more operations can be omitted in some implementations. Thus, not all illustrated operations are required in every implementation, and other process flows are possible. In some implementations, the same, different, fewer, or greater operations can be performed.

Diagram 400 illustrates host system 402 and target device 404. Target device 404 can be similar or the same as computing device 106 of FIG. 1 and/or target device 204 of FIG. 2. Host system 402 can be the same or similar to host system 132 of FIG. 1.

At operation 410, host system 402 sends an instruction to target device 404 to run (e.g., execute) an application (e.g., executable code of an application). An application can include a container, a pod, a virtual machine, a native application, an executable image, or any other program that is or can be configured to run on target device 404. The request can include identification data relating to, for example, the application, a user requesting to execute the application, etc.

At operation 415, target device 404 obtains the permissions for the application based on the corresponding security context associated with the application. In an illustrative example, target device 404 can obtain a security context identifier correlating to the application. In some implementations, the security context identifier can be encrypted with a cryptographic key or encryption standard, such as, for example, Advanced Encryption Standard (AES)-Galois/Counter Mode (GCM), AES-128, AES 256, etc. In some implementations, the cryptographic key can be a pre-shared key (PSK) or any other cryptographic key was shared with target device 304. In other implementations, the security context identifier can remain unencrypted. Target device 404 can then decrypt the security context identifier (e.g., verify the cryptographic signature), and obtain the permissions referenced by the security context.

At operation 420, target device 404 determines the current device state of target device 404. In some implementations, target device 404 can obtain the data from its OTP memory, non-volatile memory, etc. In one example relating to life cycle states, a predetermined bit(s) can be set to indicate certain life cycle states. In another example, target device 404 can use an internal clock to determine a time, a date, etc. In another example, target device 404 can determine a temperature of target device 404 using a temperature measurement device (a thermometer) coupled to target device 404.

At operation 425, target device 404 determines the data state access control policy for the target device based on the current device state. For example, target device 404 can obtain the metadata data structure (e.g., metadata table 310, 320) corresponding to the current device state (or use one or more mappings or logical statements to determine the current device state) and the security context related to the application.

At operation 430, target device 404 modifies the permissions of the security context based on the data state access control policy. For example, the target device can add access to certain assets, remove access to certain assets, etc. In some implementations, these modified permissions can be stored on the volatile or non-volatile memory of the target device for, for example, the duration of the operation of the application, for a predetermined time period, etc.

At operation 435, target device 404 runs the application under the modified permissions. For example, target device 404 can grant, to the application, access to the data assets allowed by the permissions.

At operation 440, target device 404 sends a status report to host system 402. For example, target device 404 can indicate that the application is running on target device 404.

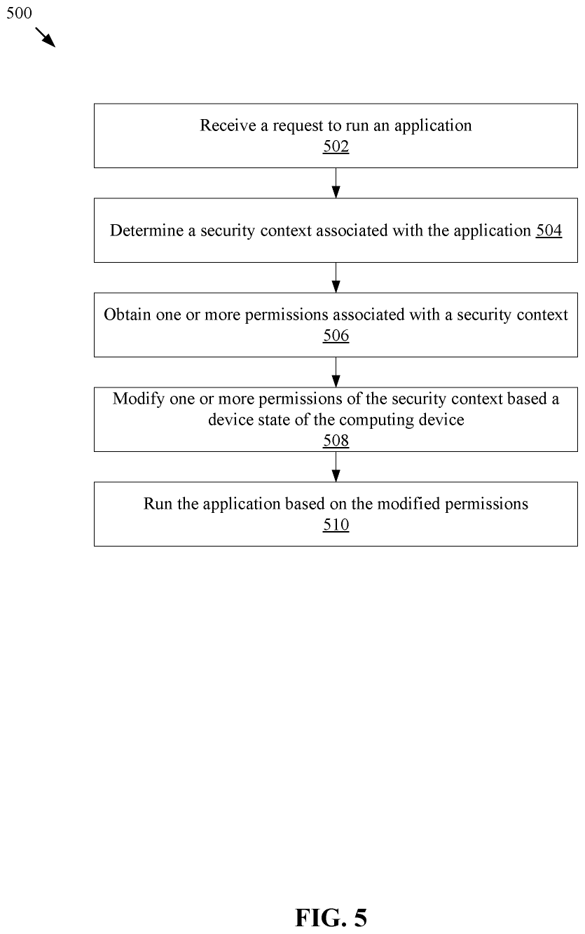

FIG. 5 depicts a flow diagram of an example method 500 of applying a device state access control policy during execution of an application, in accordance with some implementations of the disclosure. The individual functions, routines, subroutines, or operations of method 500 can be performed by a processing device, having one or more processing units (CPU) and memory devices communicatively coupled to the CPU(s). In some implementations, method 500 can be performed by a single processing thread or alternatively by two or more processing threads, each thread executing one or more individual functions, routines, subroutines, or operations of the method. Method 500 as described below can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, method 500 can be performed by computing device 106 as described in FIG. 1 and/or by target device 204, 404 as described in FIGS. 2 and 4. Although shown in a particular sequence or order, unless otherwise specified, the order of the operations can be modified. Thus, the illustrated implementations should be understood only as examples, and the illustrated operations can be performed in a different order, while some operations can be performed in parallel. Additionally, one or more operations can be omitted in some implementations. Thus, not all illustrated operations are required in every implementation, and other process flows are possible. In some implementations, the same, different, fewer, or greater operations can be performed. It can be noted that elements of FIGS. 1, 2, and 4 can be used herein to help describe FIG. 5.

At operation 502, processing logic receives a request to run an application. The request can be received from a host system in communication with the processing logic. The application can include a container, a pod, a virtual machine, a native application, an executable image, etc.

At operation 504, processing logic determines the security context associated with the application. For example, the processing logic can perform a lookup in a metadata table based on an identifier of the application.

At operation 506, processing logic obtains one or more permissions associated with the security context. For example, the processing logic can perform a look up in a hardware RoT for the permissions allowed under the specific security context.

At operation 508, processing logic modifies the one or more permissions based on a state of the computing device. In some implementations, the state of the computing device references at least one of a life cycle state of the computing device, a temperature of the computing device, a time, a date, etc. In some implementations, the state of the computing device can be indicated by an identification of the host system requesting to run the application, an identification of a user requesting to run the application, etc.

To modify the one or more permissions, the processing logic can first determine a state of the computing device. For example, the processing logic can determine a temperature of the device, a life cycle state of the device, etc. The processing logic can then obtain a device state access control policy associated with the state of the computing device and the security context. The access control policy can be referenced in a metadata table and managed by a Root of Trust of the computing device.

At operation 510, processing logic runs the application based on the modified permissions. For example, the processing logic can grant access to one or more data assets based on the modified permissions.

In some implementations, the processing logic can initially receive the device state access control policy from a provisioning device. For example, the processing logic can receive the access control policy signed with a cryptographic signature. The processing logic can then verify the cryptographic signature and store the access control policy in the hardware RoT.

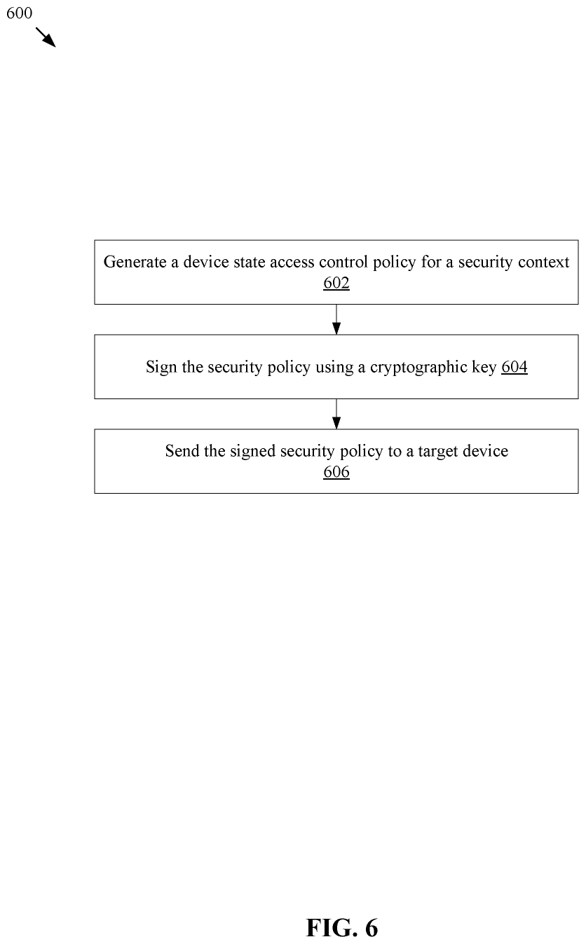

FIG. 6 depicts a flow diagram of an example method 600 of generating device state access control policy, in accordance with some implementations of the disclosure. The individual functions, routines, subroutines, or operations of method 600 can be performed by a processing device, having one or more processing units (CPU) and memory devices communicatively coupled to the CPU(s). In some implementations, method 600 can be performed by a single processing thread or alternatively by two or more processing threads, each thread executing one or more individual functions, routines, subroutines, or operations of the method. Method 500 as described below can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, method 600 can be performed by a provisioning device 202 as described in FIG. 2. Although shown in a particular sequence or order, unless otherwise specified, the order of the operations can be modified. Thus, the illustrated implementations should be understood only as examples, and the illustrated operations can be performed in a different order, while some operations can be performed in parallel. Additionally, one or more operations can be omitted in some implementations. Thus, not all illustrated operations are required in every implementation, and other process flows are possible. In some implementations, the same, different, fewer, or greater operations can be performed. It can be noted that elements of FIGS. 1 and 2 can be used herein to help describe FIG. 6.

At operation 602, processing logic generates a device state access control policy. The device state access control policy can be associated with a state of a computing device and a security context.

At operation 604, processing logic signs the security policy using cryptographic key. In other implementations, other signing or encryption method or operations can be used.

At operation 606, processing logic sends the signed security policy to the computing device.

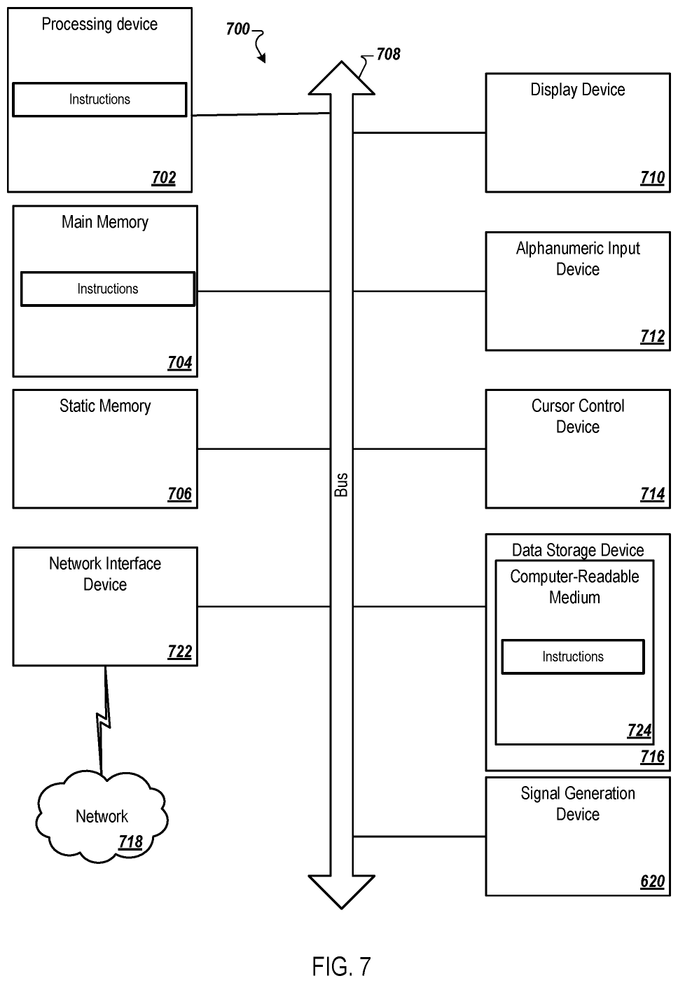

FIG. 7 is a block diagram illustrating an exemplary computer system 700, in accordance with some implementations of the disclosure. The computer system 700 executes one or more sets of instructions that cause the machine to perform any one or more of the methodologies discussed herein. Set of instructions, instructions, and the like can refer to instructions that, when executed by computer system 700, cause computer system 700 to perform one or more operations of computing device 106. The machine can operate in the capacity of a server or a client device in a client-server network environment, or as a peer machine in a peer-to-peer (or distributed) network environment. The machine can be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage device 716, which communicate with each other via a bus 708.

The processing device 702 represents one or more general-purpose processing devices such as a microprocessor, central processing unit, or the like. More particularly, the processing device 702 can be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 702 can also be one or more special-purpose processing devices such as an application specific integrated circuit (ASIC), a field programmable gate array (FPGA), a digital signal processor (DSP), network processor, or the like. The processing device 702 is configured to execute instructions of the computer system 100 for performing the operations discussed herein.

The computer system 700 can further include a network interface device 722 that provides communication with other machines over a network 718, such as a local area network (LAN), an intranet, an extranet, or the Internet. The computer system 700 also can include a display device 710 (e.g., a liquid crystal display (LCD) or a cathode ray tube (CRT)), an alphanumeric input device 712 (e.g., a keyboard), a cursor control device 714 (e.g., a mouse), and a signal generation device 720 (e.g., a speaker).

The data storage device 716 can include a non-transitory computer-readable storage medium 724 on which is stored the sets of instructions of the computer system 100 embodying any one or more of the methodologies or functions described herein. The sets of instructions can also reside, completely or at least partially, within the main memory 704 and/or within the processing device 702 during execution thereof by the computer system 700, the main memory 704 and the processing device 702 also constituting computer-readable storage media. The sets of instructions can further be transmitted or received over the network 718 via the network interface device 722.

While the example of the computer-readable storage medium 724 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that cause the machine to perform any one or more of the methodologies of the disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the disclosure can be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It can be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus can be specially constructed for the required purposes, or it can include a general purpose computer selectively activated or reconfigured by a computer program stored in the computer. Such a computer program can be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims can generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. The terms “first,” “second,” “third,” “fourth,” etc. as used herein are meant as labels to distinguish among different elements and can not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional implementations, one or more processing devices for performing the operations of the above described implementations are disclosed. Additionally, in implementations of the disclosure, a non-transitory computer-readable storage medium stores instructions for performing the operations of the described implementations. Also in other implementations, systems for performing the operations of the described implementations are also disclosed.

It is to be understood that the above description is intended to be illustrative, and not restrictive. Other implementations will be apparent to those of skill in the art upon reading and understanding the above description. The scope of the disclosure can, therefore, be determined with reference to the appended claims, along with the full scope of equivalents to which such claims are entitled.

What is claimed is:

1. A method, comprising:
receiving, by a computing device, a request to run an application, wherein the application is associated with a security context;
obtaining one or more permissions associated with the security context;
modifying the one or more permissions based on a state of the computing device; and
running the application based on the modified one or more permissions.

2. The method of claim 1, wherein modifying the one or more permissions comprises:
obtaining an access control policy associated with the state of the computing device and the security context; and
modifying the one or more permissions based on the access control policy.

3. The method of claim 2, wherein the access control policy comprises a metadata data structure.

4. The method of claim 2, wherein the access control policy is managed by a Root of Trust of the computing device.

5. The method of claim 1, wherein the state of the computing device references at least one of a life cycle state of the computing device, a temperature of the computing device, a time, a date, a measurable value or a discoverable value.

6. The method of claim 1, wherein the state of the computing device references an identification of a host system requesting to run the application or an identification of a user requesting to run the application.

7. The method of claim 1, wherein modifying the one or more permissions comprises replacing a first set of permissions associated with the security context with a second set of permissions associated with the state of the computing device.

8. The method of claim 1, wherein a permission of the set of permission enables access to a secure data asset.

9. The method of claim 1, further comprising:
receiving, from a provisioning device, an access control policy referencing one or more permission modifications, wherein the access control policy is signed with a cryptographic signature;
verifying the cryptographic signature; and
storing the access control policy.

10. A system, comprising:
a memory device; and
a processing device, couple to the memory device, to:
receive a request to run an application, wherein the application is associated with a security context;
obtain one or more permissions associated with the security context;
modify the one or more permissions based on a state of the computing device; and
run the application based on the modified one or more permissions.

11. The system of claim 10, wherein modifying the one or more permissions comprises the processing device:
obtaining an access control policy associated with the state of the computing device and the security context; and
modifying the one or more permissions based on the access control policy.

12. The system of claim 11, wherein the access control policy comprises a metadata data structure.

13. The system of claim 11, wherein the access control policy is managed by a Root of Trust of the computing device.

14. The system of claim 10, wherein the state of the computing device references at least one of a life cycle state of the computing device, a temperature of the computing device, a time, a date, a measurable value or a discoverable value.

15. The system of claim 10, wherein the state of the computing device references an identification of a host system requesting to run the application or an identification of a user requesting to run the application.

16. The system of claim 10, wherein modifying the one or more permissions comprises replacing a first set of permissions associated with the security context with a second set of permissions associated with the state of the computing device.

17. The system of claim 10, wherein a permission of the set of permission enables access to a secure data asset.

18. The system of claim 10, wherein the processor is further to:
receive, from a provisioning device, an access control policy referencing one or more permission modifications, wherein the access control policy is signed with a cryptographic signature;
verify the cryptographic signature; and
store the access control policy.

19. A method, comprising:
generating, by a processor, an access control policy associated with a state of a computing device and a security context, wherein the access control policy references a modification to be applied to a permission of the security context;
signing the security policy using a cryptographic key; and
sending the signed security policy to a computing device.

20. The method of claim 19, wherein the state of the computing device references at least one of a life cycle state of the computing device or an identification a host system requesting to run an application.
